(19) United States
(12) Patent Application Publication
(10) Pub. No.: US 2024/0158255 A1
(43) Pub. Date: May 16, 2024

(54) CERAMIC SINTERED BODY, INFRARED STEALTH MATERIAL, AND METHOD FOR MANUFACTURING CERAMIC SINTERED BODY

(71) Applicant: NEC Corporation, Tokyo (JP)

(72) Inventors: Akinobu SHIBUYA, Tokyo (JP); Taizo Shibuya, Tokyo (JP); Takashi Miyazaki, Tokyo (JP)

(73) Assignee: NEC Corporation, Tokyo (JP)

(21) Appl. No.: 18/385,709

(22) Filed: Oct. 31, 2023

(30) Foreign Application Priority Data
Nov. 15, 2022 (JP) 2022-182454

(51) Int. Cl. C01G 15/00; F41H 3/00

(52) U.S. Cl. CPC C01G 15/006; F41H 3/00; C01P 2002/50

(57) ABSTRACT

A ceramic sintered body according to an aspect of the present disclosure has a composition represented by R₃Ga₅O₁₂ or R₃Al₅O₁₂ (R represents at least two rare earth elements), and has an overall porosity of 10% or more and 30% or less.

This application is based upon and claims the benefit of priority from Japanese Patent Application No. 2022-182454, filed on Nov. 15, 2022, the disclosure of which is incorporated herein in its entirety by reference.

### TECHNICAL FIELD

The present disclosure relates to a ceramic sintered body, an infrared stealth material, and a method for manufacturing a ceramic sintered body.

### BACKGROUND ART

A material using a photonic crystal has been reported in recent years as a material to be set mainly on a surface of equipment of a vehicle, an aircraft, or a ship for the purpose of preventing detection by a sensor that detects thermal radiation. In order to set the material on a surface of equipment, it is necessary to form a multilayer thin film, and there is a large problem in terms of area enlargement and manufacturing cost. As a countermeasure therefor, an infrared stealth material using a ceramic is desired.

Patent Literature 1 (WO 2018-100653 A1) discloses a ceramic formed of a metal oxide polycrystalline and capable of performing infrared radiation having a specific emissivity spectrum by receiving thermal radiation from a heat source.

### SUMMARY

An object of the present disclosure is to provide an infrared stealth material effective in a short-wave infrared wavelength band and a medium-wave infrared wavelength band.

A ceramic sintered body according to an aspect of the present disclosure has a composition represented by R₃Ga₅O₁₂ or R₃Al₅O₁₂ (R represents at least two rare earth elements), and has an overall porosity of 10% or more and 30% or less.

According to another aspect of the present invention, there is provided an infrared stealth material formed of the ceramic sintered body.

According to another aspect of the present invention, there is provided a method for manufacturing a ceramic sintered body represented by R₃Ga₅O₁₂ or R₃Al₅O₁₂ (R represents at least two rare earth elements), the method including:
a step of firing a raw material mixture to generate a fired body formed of a rare earth oxide;
a step of grinding the fired product; and
a step of sintering grinded particles obtained by the grinding to form a sintered body having an overall porosity of 10% or more and 30% or less.

### BRIEF DESCRIPTION OF THE DRAWINGS

Exemplary features and advantages of the present invention will become apparent from the following detailed description when taken with the accompanying drawings in which:

FIG. 1 is a configuration diagram for explaining a configuration of an infrared stealth material including equipment in the present example embodiment;

FIG. 2 is a diagram illustrating a relationship between a sintering temperature and a porosity of a ceramic sintered body according to Example 1;

FIG. 3 is a diagram illustrating an emissivity spectrum of the ceramic sintered body according to Example 1 in a short-wave infrared wavelength band;

FIG. 4 is a diagram illustrating an emissivity spectrum of the ceramic sintered body according to Example 1 in a medium-wave infrared wavelength band;

FIG. 5 is a diagram illustrating a porosity dependence of an emissivity of the ceramic sintered body according to Example 1 at a wavelength of 1.5 μm;

FIG. 6 is a diagram illustrating a porosity dependence of an emissivity of the ceramic sintered body according to Example 1 at a wavelength of 3.7 μm;

FIG. 7 is a diagram illustrating a transmittance spectrum of the ceramic sintered body according to Example 1 in a short-wave infrared wavelength band; and

FIG. 8 is a diagram illustrating a transmittance spectrum of the ceramic sintered body according to Example 1 in a medium-wave infrared wavelength band.

### EXAMPLE EMBODIMENT

Next, the present example embodiment will be described in detail. Hereinafter, a ceramic sintered body, an infrared stealth material, and a method for manufacturing a ceramic sintered body according to the present disclosure will be described based on an example embodiment. Note that the following example embodiment is an example for embodying the technical idea of the present invention, and the present invention is not limited to the following ceramic sintered body, infrared stealth material, and method for manufacturing a ceramic sintered body.

### First Example Embodiment

An infrared stealth material in the present example embodiment is used for preventing detection by an infrared sensor in a short-wave infrared wavelength band and a medium-wave infrared wavelength band to be used mainly for defense. The infrared sensor detects reflected light from an object in a short-wave infrared wavelength band, and detects heat from an object in a medium-wave infrared wavelength band. In a short-wave infrared wavelength band, it is necessary to lower a reflectance, that is, to increase an absorption ratio. In addition, according to Kirchhoffs law, an object that easily absorbs light is likely to emit light at the same time, and therefore it is necessary to increase an emissivity in a short-wave infrared wavelength band. In addition, in a medium-wave infrared wavelength band, it is necessary to reduce an emissivity in such a way that heat is not detected. Therefore, in an infrared stealth material, a high emissivity is required in a short-wave infrared wavelength band, and a low emissivity (low absorptance) is required in a medium-wave infrared wavelength band.

As an infrared stealth material for a detector in a short-wave infrared wavelength band, a material having a high emissivity, such as a carbon material or an SiC ceramic, is used. However, each of these materials has a high emissivity even in a medium-wave infrared wavelength band, and thus does not function as a stealth material in a medium-wave infrared wavelength band.

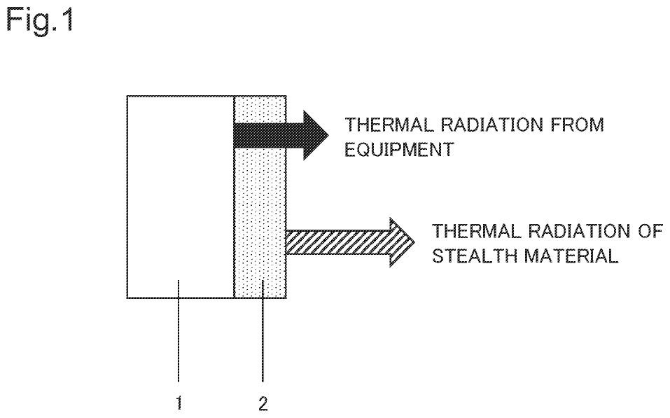

FIG. 1 is a configuration diagram for explaining a configuration of an infrared stealth material including equipment in the present example embodiment. As illustrated in FIG. 1, an infrared stealth material 2 is set on a surface of equipment 1 of a vehicle, an aircraft, a ship, or the like. In general, many ceramics exhibit transmission in a short-wave infrared wavelength band and a medium-wave infrared wavelength band. Therefore, in particular, in a case where stealth performance in a medium-wave infrared wavelength band is considered, even when the infrared stealth material 2 achieves a low absorptance (corresponding to a low emissivity), when the infrared stealth material 2 has a large transmittance, thermal radiation from the equipment 1 passes through the infrared stealth material 2, and the infrared stealth material 2 does not function as an infrared stealth material. In order to suppress radiation from the equipment 1, the transmittance of the infrared stealth material 2 is required to be low.

A ceramic sintered body in the present example embodiment has a composition represented by R₃Ga₅O₁₂ or R₃Al₅O₁₂ (R represents at least two rare earth elements). The rare earth elements are selected from at least two lanthanoid elements selected from, for example, La, Ce, Pr, Nd, Pm, Sm, Eu, Gd, Tb, Dy, Ho, Er, Tm, and Lu. The two rare earth elements have any composition ratio such as 1:1. By containing at least two rare earth elements like the sintered body in the present example embodiment, a sintered body can have radiation peaks in different wavelength bands. As a result, a sintered body can have a high emissivity in a wide wavelength band.

R represents preferably three or more rare earth elements, more preferably four or more rare earth elements. When four or more rare earth elements are contained, Sm, Ho, Er, and Tm are preferably contained. These rare earth elements have radiation peak wavelengths in different bands. Therefore, by containing these rare earth elements, a sintered body can obtain a broad radiation spectrum in a short-wave infrared wavelength band. The four rare earth elements are contained at any composition ratio such as Sm:Ho:Er:Tm=0.25:0.25:0.25:0.25.

A ceramic according to the present example embodiment is a sintered body of particles having the above composition, has pores, and has an overall porosity of 10% or more and 30% or less. The porosity is more preferably 10% or more and 20% or less. The pores are preferably randomly distributed inside the sintered body.

The above-described sintered body in the present example embodiment exhibits a high emissivity in a short-wave infrared wavelength band and exhibits a low emissivity in a medium-wave infrared wavelength band. The sintered body exhibits a low transmittance (0.15 or less) in a short-wave infrared wavelength band to a medium-wave infrared wavelength band. Therefore, according to the sintered body in the present example embodiment, it is possible to provide an infrared stealth material effective in a short-wave infrared wavelength band and a medium-wave infrared wavelength band.

(Manufacturing Method)

A method for manufacturing a ceramic sintered body according to the example embodiment of the present invention is a method for manufacturing a ceramic sintered body represented by the above composition formula, the method including:
a step of firing a raw material mixture to generate a fired body formed of a rare earth oxide;
a step of grinding the fired body; and
a step of sintering grinded particles obtained by the grinding to form a sintered body having an overall porosity of 10% or more and 30% or less.

As a raw material constituting the raw material mixture, powders of compounds containing constituent elements can be used. As a compound containing Ga, an oxide of Ga (Ga₂O₃) is preferably used. As a compound containing a rare earth element, an oxide is preferably used. Specifically, Sm₂O₃, Ho₂O₃, Er₂O₃, and Tm₂O₃ can be used for Sm, Ho, Er, and Tm, respectively.

A temperature for forming the sintered body of the grinded particles is preferably 1400 to 1550° C., more preferably 1450 to 1550° C., and still more preferably 1450 to 1500° C. from a viewpoint of obtaining a desired porosity and a desired pore distribution and from a viewpoint of sintering time (cost reduction).

The grinded particles preferably have a particle size distribution in which a maximum particle size is in a range of 20 to 40 μm and a minimum particle size does not exceed 1 μm from a viewpoint of obtaining a desired porosity and a desired pore distribution and from a viewpoint of sintering time (cost reduction). The maximum particle size of the grinded particles is more preferably in a range of 25 to 35 μm, and the minimum particle size thereof is preferably in a range of 0.1 to 1 μm. Such a particle size distribution can be confirmed by image analysis based on a scanning electron microscope (SEM) image.

The grinded particles preferably have an appropriate particle size variation. By using grinded particles having a large variation in particle size, a sintered body (ceramic) having a high porosity can be formed in a short sintering time. When the grinded particles contain appropriately large particles, a gap is easily formed between the particles, and a sufficiently large pore can be formed. By containing particles having a small particle size, the grinded particles are easily sintered. When the particle size is large and a variation in particle size is small (that is, the number of particles having a small particle size is small), sufficient sintering cannot be performed unless a temperature is raised, or sintering time is increased. When the particle size is small and a variation in particle size is small (that is, the number of particles having a large particle size is small), a sintered body having a desired porosity and a desired pore size cannot be obtained. A sintered body having a desired high porosity can be formed in a short sintering time by a balance between the particle size and the particle size distribution of the grinded particles and the sintering temperature. In consideration of this balance, a ratio of particles having a large particle size is preferably larger than a ratio of particles having a small particle size. Specifically, a ratio of small particles having a particle size of 1 μm or less preferably does not exceed 10% in volume fraction.

The grinded particles may be sintered under a pressing pressure mainly from a viewpoint of obtaining a desired porosity, a desired pore distribution, and a desired mechanical strength, and this pressure is preferably in a range of 25 to 150 MPa.

In the method for manufacturing a ceramic according to the present example embodiment, a ceramic can be manufactured by a solid-state reaction using a ceramic powder as a raw material, and therefore a ceramic can be manufactured through a simple process based on mixing of raw materials, firing, grinding, pressing, and sintering.

### EXAMPLES

### Example 1

In the present Example, a ceramic sintered body with a composition represented by a composition formula (Sm_{0.25}Ho_{0.25}Er_{0.25}Tm_{0.25})₃Ga₅O₁₂ was prepared.

First, powders of Sm₂O₃, Ho₂O₃, Er₂O₃, Tm₂O₃, and Ga₂O₃ were prepared as raw materials of ceramics.

Next, the powders were weighed to a stoichiometric ratio in such a way that a composition after synthesis was (Sm_{0.25}Ho_{0.25}Er_{0.25}Tm_{0.25})₃Ga₅O₁₂, ethanol was added thereto, and the mixture was wet-mixed in an agate mortar. The mixed material was dried and then fired at 1400° C. for eight hours in the atmosphere, and a fired product having a composition formula (Sm_{0.25}Ho_{0.25}Er_{0.25}Tm_{0.25})₃Ga₅O₁₂ was obtained by a solid-state reaction.

Thereafter, the fired body was grinded in an agate mortar to obtain grinded particles. The grinded particles were put into a die, pressed at 100 MPa, and a pellet was taken out from the die. Thereafter, the fired body was sintered in the atmosphere for two hours to obtain disk-shaped ceramic pellets (sintered body) having a thickness of 1.5 mm. Five different sintered bodies were obtained by changing the sintering temperature among 1350° C., 1400° C., 1450° C., 1500° C., and 1550° C.

<Porosity>

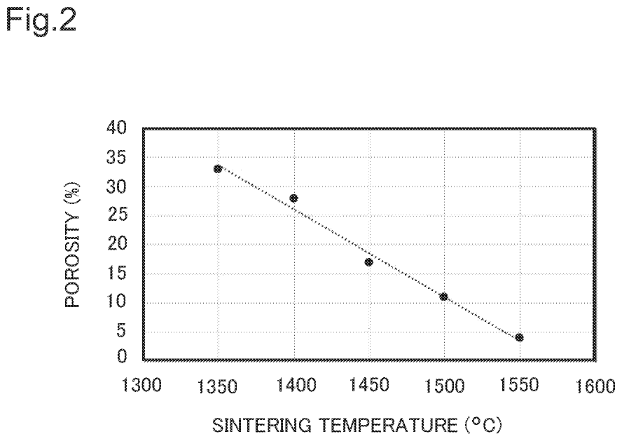

FIG. 2 is a diagram illustrating a relationship between a sintering temperature and a porosity of the ceramic sintered body according to Example 1. The porosity was measured using density measurement by an Archimedes method. In order to prevent water from entering the pores of the ceramic pellets, the density measurement was performed by coating a surface or the like of the ceramic sintered body with a cellulose-based resin. As illustrated in FIG. 2, when sintering was performed at 1400° C., 1450° C., or 1500° C., an overall porosity was 10% or more and 30% or less.

<Measurement of Crystal Structure>

The ceramic pellets were formed into a uniform powder to prepare a sample, and this sample was identified with a powder X-ray diffractometer.

<Measurement of Thermal Radiation Spectrum>

A thermal radiation spectrum of the synthesized ceramic sintered body was measured as follows.

The thermal radiation spectrum was measured by heating one surface of the disk-shaped ceramic pellets and introducing light emitted from the other surface into an FT-IR apparatus.

In the method for heating the ceramic pellets, first, a SiC plate was pressed against the disk-shaped ceramic pellets. In this state, when a surface on which the disk-shaped ceramic pellets were pressed against the SiC plate was defined as a front side, the SiC plate was heated by condensing and emitting light of a halogen lamp from a back side of the SiC plate, and heat was conducted to the ceramic pellets.

At this time, the temperature of a thermal radiation surface of the ceramic pellets and the temperature of the SiC plate were measured with a K thermocouple. Since the SiC plate had a sufficiently high thermal conductivity, the temperature of the SiC plate was estimated to be equivalent to the temperature of a heating surface of the ceramic pellets.

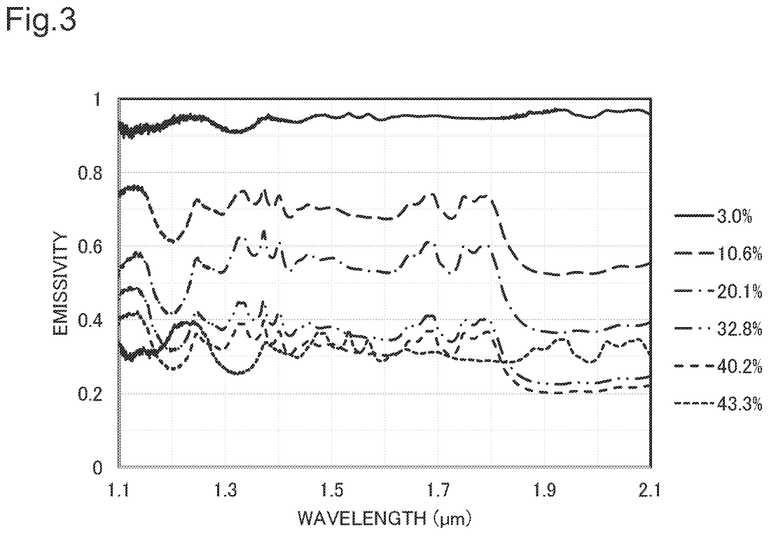

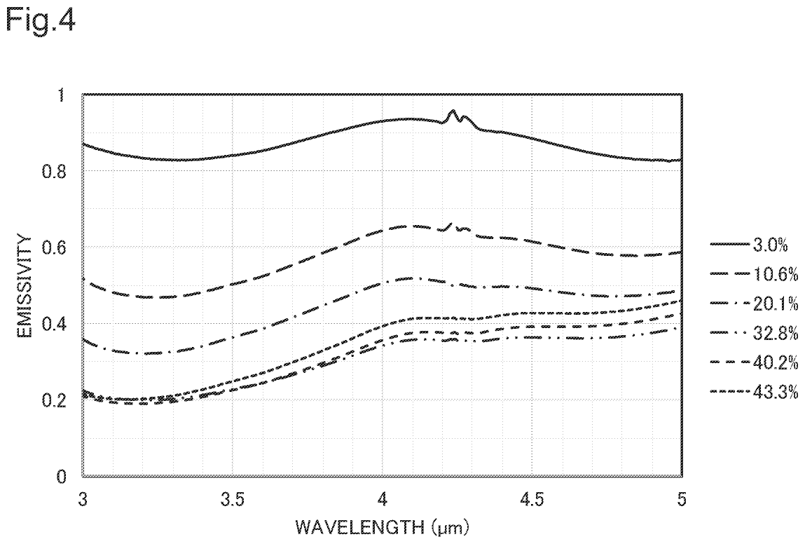

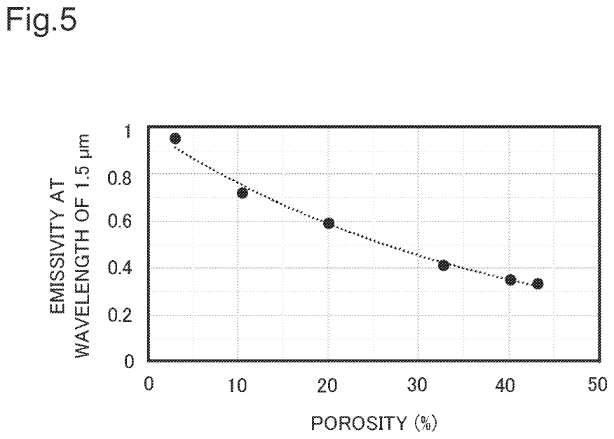

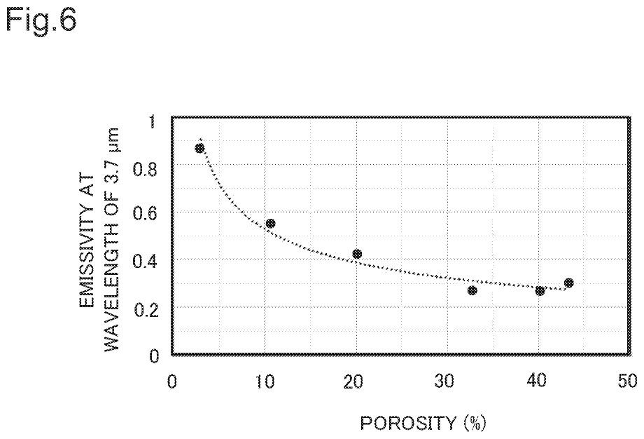

FIG. 3 illustrates a thermal radiation spectrum measurement result of the prepared ceramic sintered body in a short-wave infrared wavelength band. FIG. 4 illustrates a thermal radiation spectrum measurement result of the prepared ceramic sintered body in a medium-wave infrared wavelength band. In FIGS. 3 and 4, the horizontal axis represents a wavelength, and the vertical axis represents an emissivity. As for measurement conditions, the temperature of a front surface (infrared radiation surface) of the ceramic sintered body was 942° C., the temperature of a back surface (heating surface) of the ceramic sintered body was 1210° C., and an average temperature was 1127° C. FIG. 5 is a diagram illustrating a porosity dependence of an emissivity at a wavelength of 1.5 μm having a value substantially equal to an average emissivity in a short-wave infrared wavelength band. FIG. 6 is a diagram illustrating a porosity dependence of an emissivity at a wavelength of 3.7 μm having a value substantially equal to an average emissivity in a medium-wave infrared wavelength band.

As illustrated in FIGS. 5 and 6, it can be seen that an emissivity in a short-wave infrared wavelength band is as large as 0.4 or more when the porosity is 10% or more and 30% or less, and an emissivity in a medium-wave infrared wavelength band is suppressed to 0.6 or less when the porosity is 10% or more and 30% or less.

<Measurement of Transmittance Spectrum>

A transmittance spectrum was measured with an FT-IR apparatus using an integrating sphere. A ceramic sintered body was disposed at an infrared ray entrance of the integrating sphere, and a transmittance was measured.

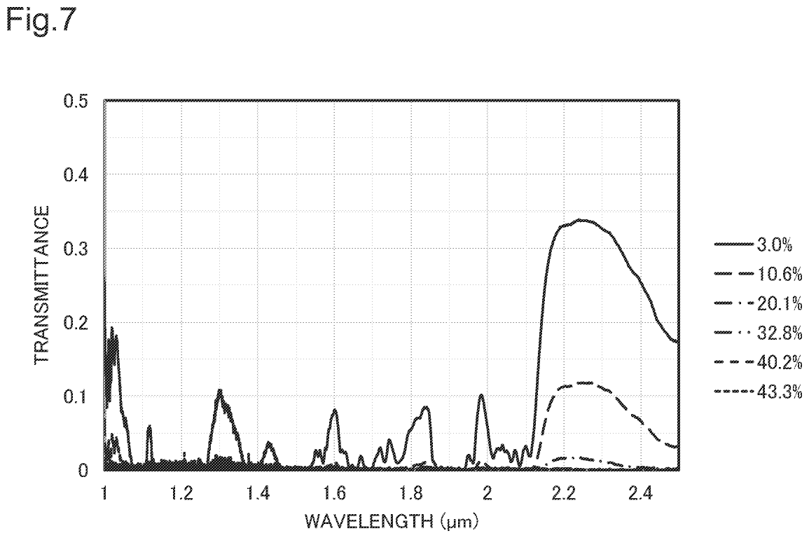

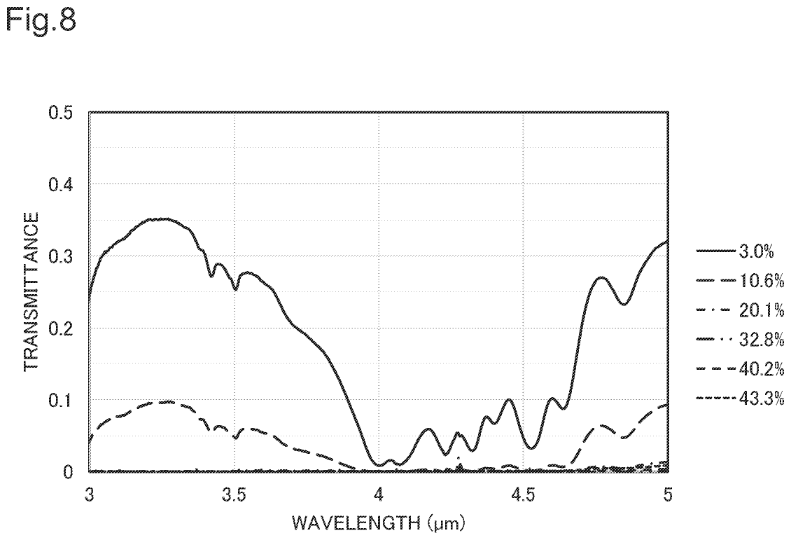

FIG. 7 illustrates a transmittance spectrum measurement result of the prepared ceramic sintered body in a short-wave infrared wavelength band. FIG. 8 illustrates a transmittance spectrum measurement result of the prepared ceramic sintered body in a medium-wave infrared wavelength band. As illustrated in FIGS. 7 and 8, due to scattering in pores, an average transmittance of 0.1 or less was obtained at a porosity of 10.6% or more in each of the bands.

In an infrared stealth material, a high emissivity is required in a short-wave infrared wavelength band (about 0.7 to 2.5 μm), and a low emissivity is required in a medium-wave infrared wavelength band (about 3.0 to 5.0 μm). However, in the ceramic described in WO 2018-100653 A1, an emissivity peak in a medium-wave infrared wavelength band is in a narrow band, and stealth performance is low.

An example of the effect of the present invention is to be able to provide an infrared stealth material effective in a short-wave infrared wavelength band and medium-wave infrared wavelength band.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A ceramic sintered body having a composition represented by R₃Ga₅O₁₂ or R₃Al₅O₁₂ (R represents at least two rare earth elements), and having an overall porosity of 10% or more and 30% or less.

2. The ceramic sintered body according to claim 1, wherein R represents four or more rare earth elements.

3. The ceramic sintered body according to claim 1, wherein R contains at least Sm, Ho, Er, and Tm as rare earth elements.

4. An infrared stealth material comprising the ceramic sintered body according to claim 1.

5. An infrared stealth material comprising the ceramic sintered body according to claim 2.

6. An infrared stealth material comprising the ceramic sintered body according to claim 3.

7. A method for manufacturing a ceramic sintered body represented by R₃Ga₅O₁₂ or R₃Al₅O₁₂ (R represents at least two rare earth elements), the method comprising:
firing a raw material mixture to generate a fired body formed of a rare earth oxide;
grinding the fired product; and
sintering grinded particles obtained by the grinding to form a sintered body having an overall porosity of 10% or more and 30% or less.

8. The method for manufacturing a ceramic sintered body according to claim 7, wherein a temperature at the time of the sintering is in a range of 1400 to 1500° C.
